(19) United States
(12) Patent Application Publication
(10) Pub. No.: US 2015/0223198 A1
(43) Pub. Date: Aug. 6, 2015

(54) Managing an Active Timer in a Power Save State

(71) Applicant: Nokia Solutions and Networks Oy, Espoo (FI)

(72) Inventors: Lei Du, Beijing (CN); Woonhee Hwang, Espoo (FI)

(73) Assignee: Nokia Solutions and Networks Oy, Espoo (FI)

(21) Appl. No.: 14/169,306

(22) Filed: Jan. 31, 2014

(51) Int. Cl. H04W 68/02; H04W 52/02

(52) U.S. Cl. CPC H04W 68/02; H04W 52/0203

(57) ABSTRACT

A method includes determining at a network node whether paging to be sent from the network node toward an intermediate node for further forwarding to a user equipment will arrive at the user equipment before the user equipment transitions from an idle state to a power save state. The method includes sending or not sending the paging toward the intermediate node based on the determining. Another method includes performing an estimation at a network access node providing wireless network access to a user equipment of how long it will take before a next paging frame or paging occasion occurs for the user equipment, and sending to a network node a value indicative of the estimation. Apparatus, computer programs, and computer program products are also disclosed corresponding to the methods.

### TECHNICAL FIELD

This invention relates generally to wireless communication and, more specifically, relates to paging of user equipment.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below at the end of the specification but prior to the claims.

The TSG Service and System Aspects (TSG-SA) is responsible for the overall architecture and service capabilities of systems based on 3GPP specifications. One working group within the TSG-SA is the SA WG2 (SA working group 2, commonly abbreviated as SA2), which is in charge of developing stage 2 of the 3GPP network. In SA2, there has been a work item to enhance MTC performance including small data transmission, UE power consumption, and the like. See S2-121866, “Machine Type and Smartphone Communications Enhancements”, 3GPP TSG SA WG2 Meeting #90, 16-20 Apr. 2012, Bratislava, Slovakia. Among several candidate solutions for UE power consumption (e.g., see 3GPP TR 23.887 v12.0.0), including extended DRX, power saving state (PSS), attach/detach, and the like, PSS is to be further specified in Rel-12. The idea is that a UE enters the PSS at certain times in order to save power.

As a result, a WI has been approved during the RAN #62 meeting to study the RAN enhancements for MTC and other mobile data applications communications. See RP-131675, “RAN enhancements for Machine-Type and other mobile data applications Communications”, 3GPP TSG-RAN Meeting #62, Busan, South Korea, Dec. 3-6, 2013. In particular, this WI aims to investigate the PSS solution that has been under study in CT1 and to identify the impact to UE AS behavior and therefore the corresponding RAN2/RAN3 specification. In more detail, CT1 is another working group in 3GPP. This working group is responsible for the 3GPP specifications that define the User Equipment—Core network L3 radio protocols and Core network side of the Iu reference point. The specification work of PSS starts from CT1 and then the RAN group decides to investigate whether there is any impact to the RAN side of the specifications.

However, when the UE is in a PSS, many functions are not available. For instance, a UE typically is not reachable for paging. Thus, it would be beneficial to consider items such as paging while the UE is in the PSS.

### SUMMARY

This section contains examples of possible implementations and is not meant to be limiting.

In an exemplary embodiment, a method comprises the following: determining at a network node whether paging to be sent from the network node toward an intermediate node for further forwarding to a user equipment will arrive at the user equipment before the user equipment transitions from an idle state to a power save state; and sending or not sending the paging toward the intermediate node based on the determining.

Another exemplary embodiment is a method as above, wherein determining further comprises determining whether a time period has or has not expired, wherein the time period is based in part on an active time period used by the user equipment to determine a length of the idle state and when to transition to the power save state. A method as in this paragraph, wherein the time period is set to the active time period minus a predetermined value.

A method as above, wherein determining further comprises determining whether a time period has or has not expired, wherein the time period is determined by subtracting a predetermined value from an active time period used by the user equipment to determine a length of the idle state and when to transition to the power save state; and wherein sending or not sending the paging toward the intermediate node based on the determining further comprises: sending the paging toward the intermediate node in response to the time period not expiring; and not sending the paging toward the intermediate node in response to the time period expiring.

A method as above, wherein: determining further comprises determining whether there will be any paging occasion falling into a remaining active time period, wherein the active time period is used by the user equipment to determine a length of the idle state and when to transition to the power save state; and sending or not sending the paging toward the intermediate node based on the determining further comprises: sending the paging toward the intermediate node in response to a determination there will be a paging occasion falling into the remaining active time period; and not sending the paging toward the intermediate node in response to a determination there will not be a paging occasion falling into the remaining active time period. A method as in this paragraph, wherein: the method further comprises receiving a value from the intermediate node; and determining whether there will be any paging occasion falling into a remaining active time period further comprises determining, based at least on the value, a time instant determined based on when the paging is received, and a length of time of a paging cycle whether there will be any paging occasion falling into the remaining active time period. A method as in this paragraph, further comprising determining the remaining active time period at least by setting a timer in response to reception from the intermediate node of a message, indicating the user equipment has transitioned to the idle state, to the active time and using at least a time instant determined based on when the paging is received and the timer to determine the remaining active time period. A method as in this paragraph, wherein: determining further comprises determining whether a following relationship is true: upperround((T−delta2)/pagingCycle)*pagingCycle+delta2<activetime, wherein the function upperround( ) rounds up to a nearest integer, T is a time instant determined based on when the paging is received and is relative to a beginning of the timer, delta2 is a value received from the intermediate node, the variable pagingCycle is a time period of a paging cycle, and the variable activetime is the active time period used by the user equipment; sending the paging further comprises sending the paging toward the intermediate node in response to the relationship being true; and not sending the paging further comprises not sending the paging toward the intermediate node in response to the relationship being false.

An exemplary apparatus includes one or more processors and one or more memories including computer program code. The one or more memories and the computer program code are configured to, with the one or more processors, cause the apparatus to perform any of the methods described in the previous paragraphs.

In an exemplary embodiment, an apparatus comprises the following: means for determining at a network node whether paging to be sent from the network node toward an intermediate node for further forwarding to a user equipment will arrive at the user equipment before the user equipment transitions from an idle state to a power save state; and means for sending or not sending the paging toward the intermediate node based on the determining.

A further exemplary embodiment is an apparatus as above, wherein the means for determining further comprises means for determining whether a time period has or has not expired, wherein the time period is based in part on an active time period used by the user equipment to determine a length of the idle state and when to transition to the power save state. An apparatus as in this paragraph, wherein the time period is set to the active time period minus a predetermined value.

An apparatus as above, wherein the means for determining further comprises means for determining whether a time period has or has not expired, wherein the time period is determined by subtracting a predetermined value from an active time period used by the user equipment to determine a length of the idle state and when to transition to the power save state; and wherein the means for sending or not sending the paging toward the intermediate node based on the determining further comprises: means for sending the paging toward the intermediate node in response to the time period not expiring; and means for not sending the paging toward the intermediate node in response to the time period expiring.

An apparatus as above, wherein: the means for determining further comprises means for determining whether there will be any paging occasion falling into a remaining active time period, wherein the active time period is used by the user equipment to determine a length of the idle state and when to transition to the power save state; and the means for sending or not sending the paging toward the intermediate node based on the determining further comprises: means for sending the paging toward the intermediate node in response to a determination there will be a paging occasion falling into the remaining active time period; and means for not sending the paging toward the intermediate node in response to a determination there will not be a paging occasion falling into the remaining active time period. An apparatus as in this paragraph, wherein: the apparatus further comprises means for receiving a value from the intermediate node; and the means for determining whether there will be any paging occasion falling into a remaining active time period further comprises means for determining, based at least on the value, a time instant determined based on when the paging is received, and a length of time of a paging cycle whether there will be any paging occasion falling into the remaining active time period. An apparatus as in this paragraph, further comprising means for determining the remaining active time period at least by setting a timer in response to reception from the intermediate node of a message, indicating the user equipment has transitioned to the idle state, to the active time and means for using at least a time instant determined based on when the paging is received and the timer to determine the remaining active time period. An apparatus as in this paragraph, wherein: the means for determining further comprises means for determining whether a following relationship is true: upperround((T−delta2)/pagingCycle)*pagingCycle+delta2<activetime, wherein the function upperround( ) rounds up to a nearest integer, T is a time instant determined based on when the paging is received and is relative to a beginning of the timer, delta2 is a value received from the intermediate node, the variable pagingCycle is a time period of a paging cycle, and the variable activetime is the active time period used by the user equipment; the means for sending the paging further comprises means for sending the paging toward the intermediate node in response to the relationship being true; and means for not sending the paging further comprises not sending the paging toward the intermediate node in response to the relationship being false. A mobility management unit comprises any of the apparatus in the preceding paragraphs.

In a further exemplary embodiment, a method comprises the following: performing an estimation at a network access node providing wireless network access to a user equipment of how long it will take before a next paging frame or paging occasion occurs for the user equipment; and sending to a network node a value indicative of the estimation of how long it will take before the next paging frame or paging occasion occurs for the user equipment.

A method as in the previous paragraph, wherein the estimating is performed in response to sending one of a user equipment context release complete message to the network node or performing a radio resource control connection release with the user equipment. A method as above, wherein sending comprises sending the value to the network node in a user equipment context release complete message.

An exemplary apparatus includes one or more processors and one or more memories including computer program code. The one or more memories and the computer program code are configured to, with the one or more processors, cause the apparatus to perform any of the methods described in the preceding two paragraphs.

In a further exemplary embodiment, an apparatus comprises the following: means for performing an estimation at a network access node providing wireless network access to a user equipment of how long it will take before a next paging frame or paging occasion occurs for the user equipment; and means for sending to a network node a value indicative of the estimation of how long it will take before the next paging frame or paging occasion occurs for the user equipment.

An apparatus as in the previous paragraph, wherein the estimating is performed in response to sending one of a user equipment context release complete message to the network node or performing a radio resource control connection release with the user equipment. An apparatus as above, wherein the means for sending comprises means for sending the value to the network node in a user equipment context release complete message. A base station comprises the apparatus as in this paragraph and the preceding two paragraphs.

An exemplary computer program product includes a computer-readable storage medium bearing computer program code embodied therein for use with a computer. The computer program code includes code for performing any of the methods above.

An additional exemplary embodiment includes a computer program, comprising code for performing any of the methods described above when the computer program is run on a processor. The computer program according to this paragraph, wherein the computer program is a computer program product comprising a computer-readable medium bearing computer program code embodied therein for use with a computer.

A system includes any of the apparatus described above.

### BRIEF DESCRIPTION OF THE DRAWINGS

In the attached Drawing Figures:

FIG. 1 is a block diagram of an exemplary system in which the exemplary embodiments may be practiced;

FIG. 2 illustrates a power saving state solution as described in 3GPP TR 23.887 v12.0.0;

FIG. 3 is a signaling diagram using to illustrate a scenario for the power saving state solution;

FIG. 4 is a signaling diagram used to illustrate signaling in an exemplary embodiment;

FIG. 5 is a logic flow diagram illustrating the operation of an exemplary method, a result of execution of computer program instructions embodied on a computer readable memory, and/or functions performed by logic implemented in hardware, in accordance with an exemplary embodiment;

FIG. 6 is a signaling diagram used to illustrate signaling in an exemplary embodiment; and

FIGS. 7-9 are logic flow diagrams illustrating the operation of exemplary methods, a result of execution of computer program instructions embodied on a computer readable memory, and/or functions performed by logic implemented in hardware, in accordance with exemplary embodiments.

### DETAILED DESCRIPTION OF THE DRAWINGS

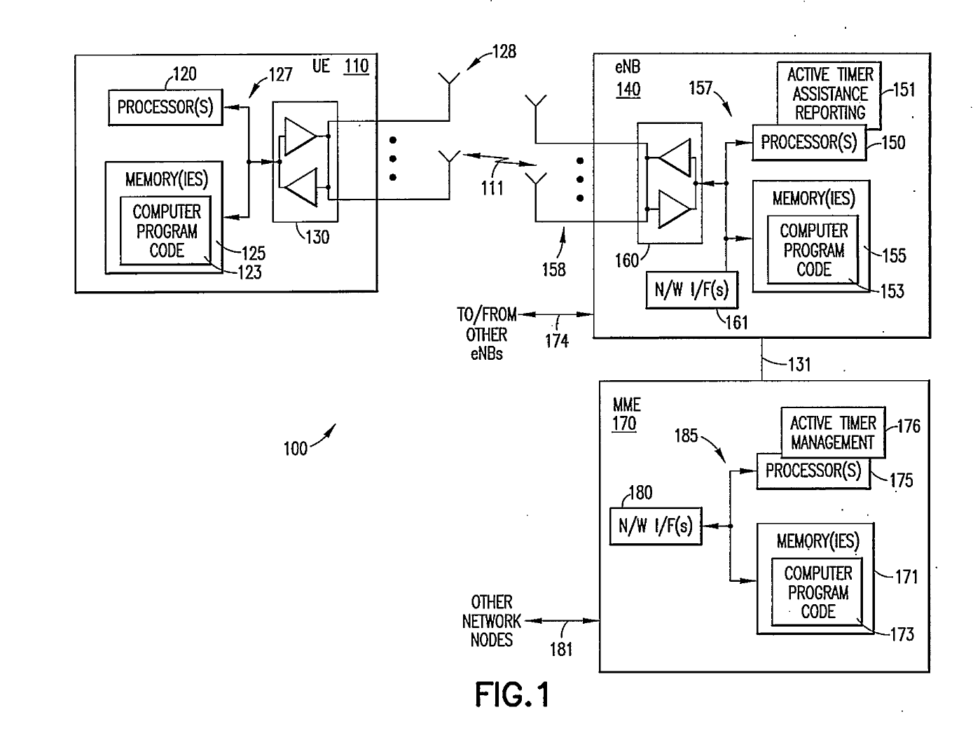

Before proceeding with additional description of problems and solutions herein to those problems, reference is made to FIG. 1, which shows a block diagram of an exemplary system in which the exemplary embodiments may be practiced. In FIG. 1, a UE 110 is in wireless communication with a network 100. The user equipment 110 includes one or more processors 120, one or more memories 125, and one or more transceivers 130 interconnected through one or more buses 127. The one or more transceivers 130 are connected to one or more antennas 128. The one or more memories 125 include computer program code 123. In an exemplary embodiment, the one or more memories 125 and the computer program code 123 are configured to, with the one or more processors 120, cause the user equipment 110 to perform one or more operations. The UE 110 communicates with eNB 140 via link 111.

The eNB 140 is a network access node that provides access by the UE 110 to the network 100. The eNB 140 includes one or more processors 150, one or more memories 155, one or more network interfaces (N/W I/F(s)) 161, and one or more transceivers 160 interconnected through one or more buses 157. The one or more transceivers 160 are connected to one or more antennas 158. The one or more memories 155 include computer program code 153. In an exemplary embodiment, the one or more memories 155 and the computer program code 153 are configured to, with the one or more processors 150, cause the eNB 140 to perform one or more of the operations as described herein. The eNB 140 comprises an active timer assistance reporting module 151, which performs certain operations described herein (e.g., see Alternative #2 below). The active timer assistance reporting module 151 may be implemented in part or wholly as computer program code 153. The active timer assistance reporting module 151 may also be implemented in part or wholly as hardware, such as an application specific integrated circuit, a programmable gate array, and the like, as part of the one or more processors 150 or separately from the one or more processors 150.

The one or more network interfaces 161 communicate over a network such as the networks 174 and 131. Two or more eNBs 140 communicate using, e.g., network 174. The network 174 may be wired or wireless or both and may implement, e.g., an X2 interface.

The wireless network 100 may include an MME 170, which is a network node that may also provide connectivity with other network nodes (not shown in FIG. 1) in a core network, such as a serving gateway (SGW) or a home subscriber server (HSS). The eNB 140 is coupled via a network 131 to the MME 170. The network 131 may be implemented as, e.g., an S1-MME interface. The MME 170 includes one or more processors 175, one or more memories 171, and one or more network interfaces (N/W I/F(s)) 180, interconnected through one or more buses 185. The one or more memories 171 include computer program code 173. In an exemplary embodiment, the one or more memories 171 and the computer program code 173 are configured to, with the one or more processors 175, cause the MME 170 to perform one or more operations described herein. The MME 170 comprises an active timer management module 176, which performs certain operations described herein. The active timer management module 176 may be implemented in part or wholly as computer program code 173. The active timer management module 176 may also be implemented in part or wholly as hardware, such as an application specific integrated circuit, a programmable gate array, and the like, as part of the one or more processors 175 or separately from the one or more processors 175. The one or more network interfaces 180 may communicate over network interfaces 131 and 181 and the like.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 150, and 175 may be of any type suitable to the local technical environment, and may include one or more of general purpose computers, special purpose computers, microprocessors, digital signal processors (DSPs) and processors based on a multi-core processor architecture, as non-limiting examples.

Regarding potential problems with conventional techniques, the concept of the power saving state is described in section 7.1.3.3 of 3GPP TR 23.887 v12.0.0. This section states the following: “The solution introduces a power saving state that a UE may adopt when there are longer periods of inactivity (in the range of multiple minutes or hours). The basic idea behind the solution is that a UE can be configured so that the UE is reachable for downlink data only during the time that the UE is in RRC/S1 connected state plus an active time period that follows the connected state during which the UE is reachable for paging, i.e. the active time period is after the UE changed to idle state. The UE starts the active timer after transiting to the idle state. When the active timer expires, the UE changes to a ‘power saving state’. Depending on device configuration the applications of the device may change the device back to normal network operation state, e.g. when an application of the device needs to transfer data.”

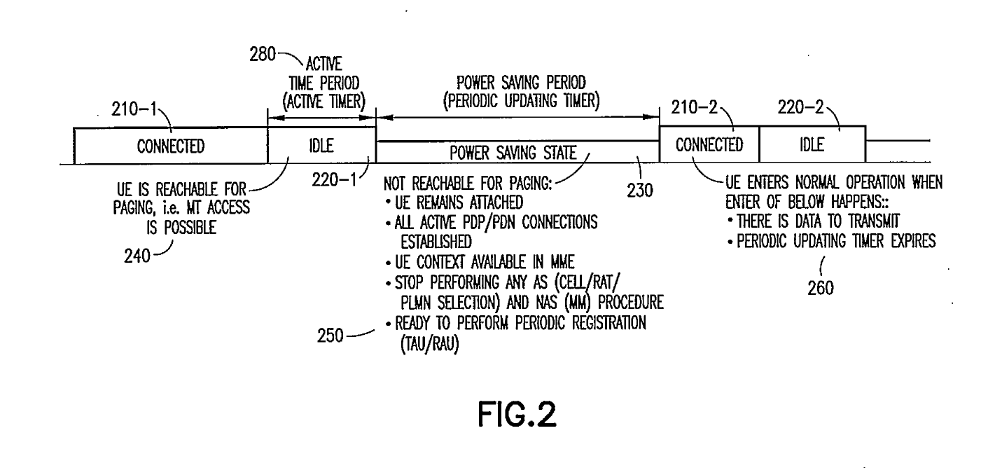

FIG. 2 shows how the UE switches between different states in the power saving state solution as described in 3GPP TR 23.887 v12.0.0. In addition to the normal state transition between RRC connected state 210 and idle state 220, the UE 110 starts an active timer after transiting to the idle state 220. In this example, two connected states 210-1 and 210-2 are shown, and two ide states 220-1 and 220-2 are shown. In the idle state 220, the UE is reachable for paging, i.e., MT access is possible (see reference 240). The UE also starts the active timer 280 in the idle state 220. The active timer 280 is allocated by the network, but could take into account the UE's preference if any. When the active timer 280 expires, the UE changes to the “power saving state” (PSS) 230. As indicated by reference 250, in the power saving state 230, the UE is not reachable for paging, as the UE performs the following: the UE remains attached; all active PDP/PDN connections are established; the UE context is available in the MME 170; the UE stops performing an AS (cell/RAT/PLMN selection) and NAS (MM) procedure(s); and the UE is ready to perform periodic registration (TAU/RAU). As indicated by reference 260, the UE enters normal operation (e.g., the connected state 210) in response to either of the following happening: there is data to transmit; or a periodic updating timer expires.

As the UE is not reachable by paging during the power saving state 230 after the active timer 280 is expired, the MME 170 needs to keep a version of the same timer (e.g., a reachability timer) to prohibit itself from sending paging after the active timer 280 is expired, e.g., by setting a value of the reachability timer to a value of the active timer 280. However, it may happen that the paging message is sent out at the MME 170 before the active timer 280 expires but the paging occasion where the paging message is sent out by eNB 140 is beyond the active time period. In that case, the paging message unnecessarily consumes the S1 and air resource in the whole tracking area but is not able to reach the UE 110.

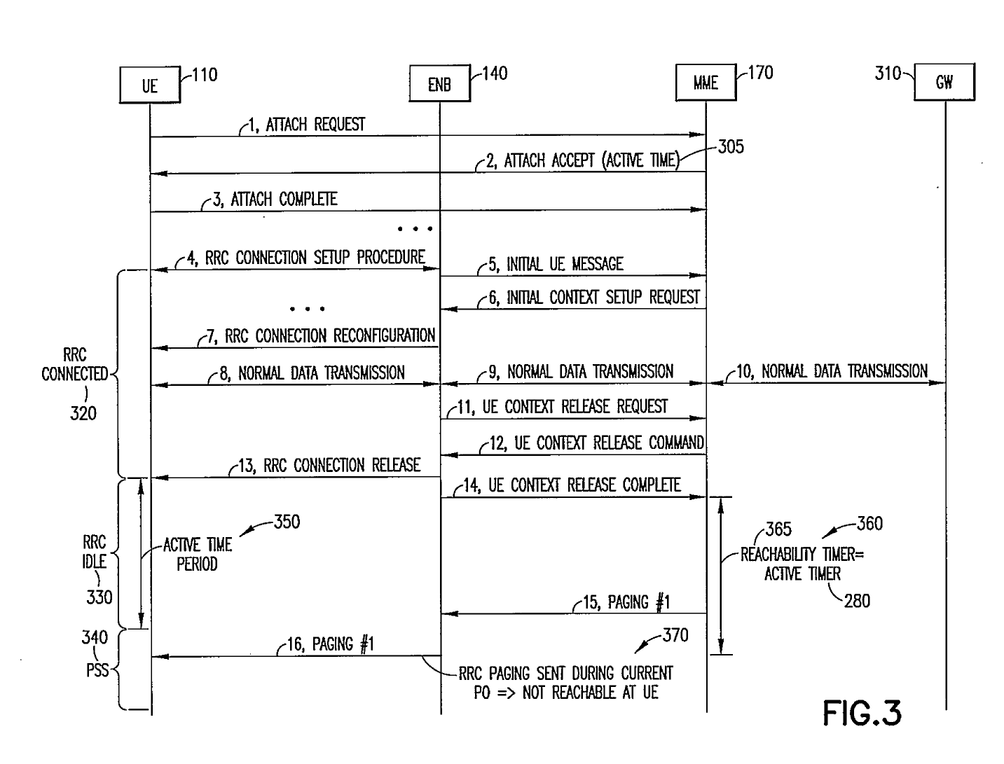

FIG. 3 is used to illustrate this example in more detail. In FIG. 3, which is a signaling diagram using to illustrate a scenario for the power saving state solution, the entities involved are the UE 110, the eNB 140, the MME 170, and another network node, a gateway (GW) 310. In this example, the RRC connected state 320, RRC idle state 330, and PSS 340 are shown for the UE 110. The following signaling operations are performed. In operation 1, the UE 110 sends an attach request message to the MME 170. In operation 2, the MME 170 responds to the UE 110 with an attach accept message with an active time 305. The active time 305 is used by the UE to set the active timer 280. In operation 3, the UE 110 sends an attach complete message to the MME 170.

In operation 4, the UE 110 performs an RRC connection setup procedure with the eNB 140. In operation 5, the eNB 140 sends an initial UE message to the MME 170. In operation 6, the MME 170 responds to the eNB 140 with an initial context setup request message. In operation 7, the eNB 140 performs an RRCE connection reconfiguration with the UE 110.

In operations 8, 9, and 10, a normal data transmission occurs involving the UE 110, eNB 140, MME 170, and the GW 310. For operation 11, the eNB 140 sends a UE context release request message 11 to the MME 170 and the MME 170 responds in operation 12 with a UE context release command. In operation 13, the eNB 140 performs an RRC connection release with the UE 110.

In response to operation 13, the UE 110 sets the active timer 280 by using the active time 305 previously received in operation 2. The active time period 350 shown is in response to the setting of the active timer 280. In operation 14, the eNB 140 sends a UE context release complete message to the MME 170. In response, as indicated by reference 360 the MME 170 sets the reachability timer 365 equal to a value of the active timer 280. Meanwhile the active time period 350 is occurring at the UE 110 in the RRC idle state 330. Based on the reachability timer 365, the MME 170 in operation 15 sends a paging message (#1) to the eNB 140. However, as the eNB could send the paging message only on specific paging frame and paging occasion (see section 7 in 3GPP TS 36.304, e.g., 3GPP TS 36.304 V11.6.0 (2013-December)), the eNB 140 forwards the paging message (in operation 16) to the UE 110 after the UE 110 has entered the PSS 340. As indicated by reference 370, the RRC page sent during the current PO is not reachable at the UE. In other words, even though the MME 170 believes a paging will be successful, the UE 110 has entered the PSS 340 and the page does not reach the UE 110.

A possible optimization is that the MME 170 includes a remaining time period for the active timer in the paging messages (e.g., in operation 15). Upon receiving the paging message from the MME, the eNB selects a proper PO within the received time period from the MME. If the eNB cannot find a PO within the time period from the MME, the eNB stops the paging procedure in the RAN. See 3GPP TR 23.887 v12.0.0, e.g., section 7.1.3.3.1.

However, the timer is running while the paging message is sent from the MME 170 to the eNB 140. The remaining time period once the message arrives at the eNB is therefore not accurate. In addition, UE context is not available at the eNB after the connection is released (e.g., in operation 13). Sending the eNB the remaining active time requires the eNB to maintain the timer for UEs in idle mode which violates a current principle. Some other solutions need to be considered to solve the problem.

The instant exemplary embodiments solve or ameliorate these problems. Two exemplary alternatives are presented below, although the instant solutions are not limited to these alternatives.

In one alternative (Alternative #1), it is proposed that the MME 170 sets a reachability timer 365 to a value less than the value of the active timer 280 set by the UE 110. The difference between the timers 280, 365 at the UE and MME, e.g., a delta referred to as delta1 herein, could be specified or decided by the MME as an implementation matter. More specifically this exemplary embodiment alternative includes following options:
The delta between the reachability timer 365 at the MME and the active timer 280 at UE could be predefined in the specification, e.g., 10 seconds; and/or
The delta could be a vendor-specific value set by the MME.

In particular, the delta could be set to a value of the default paging cycle, and the value (referred to as “pagingCycle” below) of the default paging cycle could be sent from the eNB to the MME, e.g., in an eNB configuration message.

The proposed method above could alleviate the problem of sending paging unnecessarily by stopping the sending of paging at the MME at an early enough point. This is the safest solution (between Alternatives #1 and #2, where #2 is also described below) but brings certain inefficiency, in that a paging message which could have been received by UE 110 was not sent from MME 170. For instance, whether the UE could receive the paging message depends on the time period between the time the eNB receives the paging message and the time eNB sends the paging message to UE, i.e. the PF/PO. The information about PF/PO could be useful for the MME to have in order to determine whether to send the paging or not.

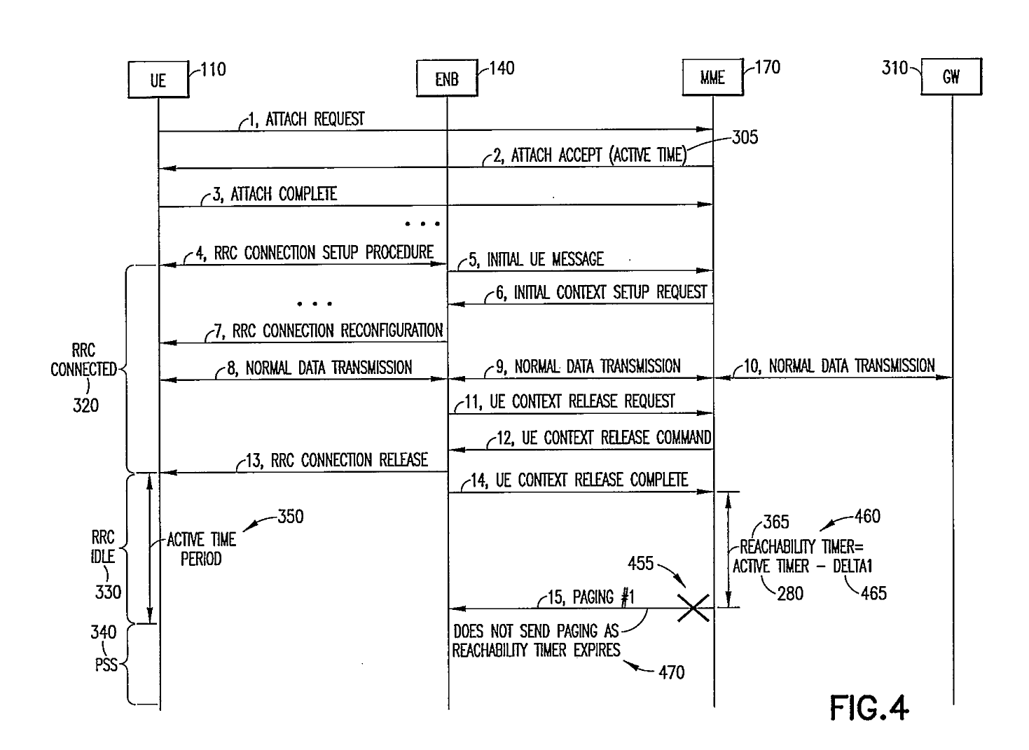

An exemplary signaling flow for Alternative #1 is illustrated in FIG. 4. Most of the operations in FIG. 4 have already been described in reference to FIG. 3, so only the differences are described in reference to FIG. 4. In FIG. 4, in reference 460, the MME 170 sets its active timer, i.e., reachability timer 365, to a value less than the active timer 280 sent to UE as the active time 305 in operation 2. The delta1 465 is used to subtract from the value of the active timer 280. As indicated by reference 470, the MME 170 shall not send the paging message (as indicated by reference 455) in response to the reachability timer 365 expiring (although the active timer 280 at the UE does not expire until after the reachability timer 365 expires).

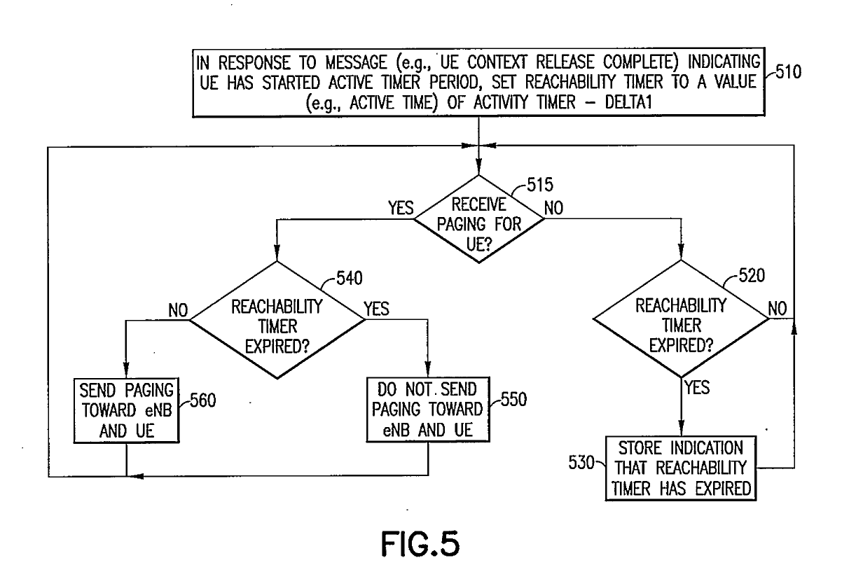

FIG. 5 is a logic flow diagram illustrating the operation of an exemplary method, a result of execution of computer program instructions embodied on a computer readable memory, and/or functions performed by logic implemented in hardware, in accordance with an exemplary embodiment. FIG. 5 is performed by an MME, e.g., under control of the active timer management module 176. The blocks in FIG. 5 may be considered to be interconnected means for performing the functions in the blocks.

In block 510, the MME 170, in response to a message (e.g., UE context release complete) indicating UE has started its active time period, sets a reachability timer 365 to a value of the active timer 280—delta1 (see also 460 of FIG. 4). As illustrated in FIG. 4, the active time 305 is typically the value of the active timer 280. As stated above, the delta1 could be specified or decided by the MME as an implementation matter. In block 515, the MME 170 determines if paging has been received (e.g., from the serving gateway 310) for the UE. If not (block 515=No), in block 520, the MME 170 determines whether the reachability timer has expired. If not (block 520=No), the flow proceeds to block 515. If so (block 520=Yes), the flow proceeds to block 530, where the MME 170 stores an indication that the reachability timer 365 has expired. Note that this could be an indication separate from the reachability timer 365, or the reachability timer 365 could simply be set to (or left at) a predetermined value such as zero as an example.

If paging was received (block 515=Yes), the flow proceeds to block 540, where the MME 170 determines whether the reachability timer 365 has expired. If the reachability timer 365 has expired (block 540=Yes), in block 550, the MME 170 does not send the paging toward the eNB 140 (and therefore toward the UE 110). In contrast, if the reachability timer 365 has not expired (block 540=No), the MME 170 in block 560 sends the paging toward the eNB 140 and the UE 110. One exemplary way to determine whether the reachability timer 365 expired is to check the indication from block 530, which as described above could be separate from the reachability timer 365, or the reachability timer 365 could simply be set to (or left at) a predetermined value such as zero as an example.

Another exemplary alternative (Alternative #2) is as follows. It is proposed that the eNB 140 sends assistance information to the MME 170 and the MME determines whether to send the paging based on the received assistance information. The assistance information could include the following: the time period required to send the paging message, i.e., the next PF/PO, when the eNB sends the UE context release complete message, e.g., the number of the radio frames (each being 10 ms) or the value approximating to seconds, to the MME. In response to receiving the information, the MME 170 could determine whether it is possible to find a PO before the active timer (e.g., as indicated by the reachability timer) expires.

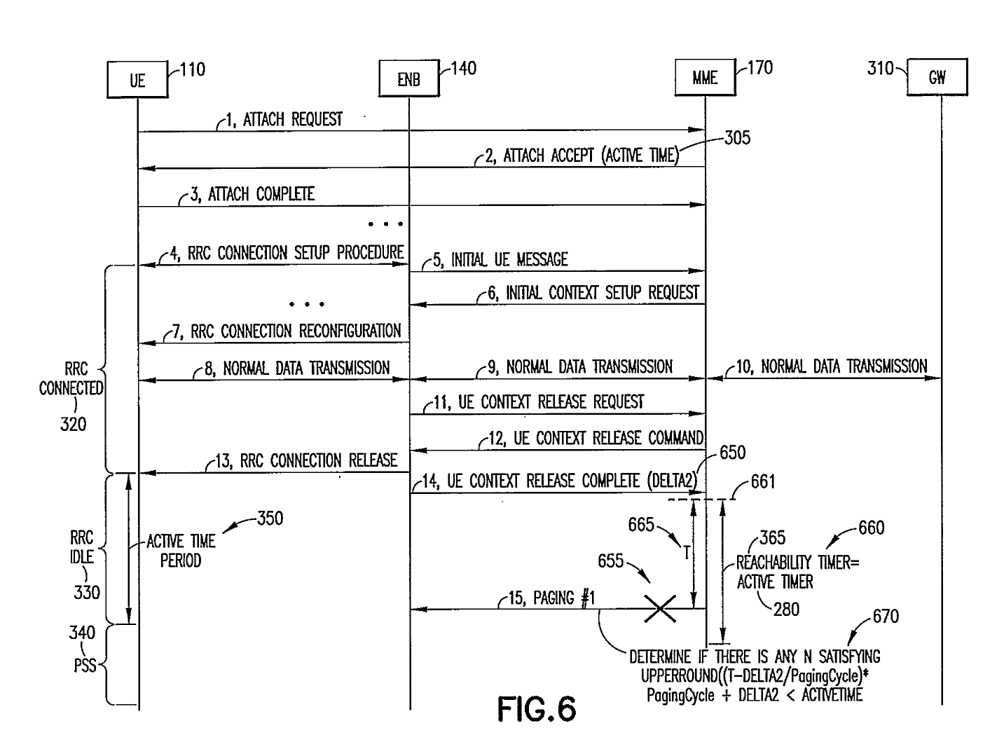

An exemplary signaling flow for Alternative #2 is illustrated in FIG. 6. Most of this signaling has been described in FIG. 3 and only the differences are described here. In FIG. 6, the eNB estimates how long it will take before the next paging frame or paging occasion occurs, e.g., from a time instant corresponding to when the eNB is to send a UE context release complete message to the MME or possibly in response to an RRC connection release between the eNB and the UE. For instance, the eNB 140 can determine when the next paging frame or paging occasion occurs and then can determine from this information an estimate of time from a current time. The eNB 140 includes a value, referred to as delta2 650, corresponding to this estimate into, e.g., the UE context release complete message in operation 14. The eNB 140 is able to send the default paging cycle to the MME 170 in a previous eNB configuration procedure. In response to receiving the UE context release complete message in operation 14, the MME will set (reference 660) a value of the reachability timer 365 to a value of the active timer 280 (e.g., using the active time 305 sent in operation 2). The time T 665 is a time from a start 661 of the reachability timer and is determined in response to paging being received by the MME 170 for the UE 110. In response to receiving the delta2 650 from the eNB, the MME 170 is able to determine (reference 670) whether the relationship upperround((T−delta2)/pagingCycle)*pagingCycle+delta2<activetime is true or false. The variable “activetime” is the value of active time 305 sent in operation 2. The variable pagingCycle is a time period of a paging cycle. The function upperround( ) rounds up to the nearest integer. This exemplary equation refers to exactly the “next upcoming” paging occasion after the MME sends the paging message. So if this position falls within the active time period, it means there will be at least one PO before the reachability timer expires, so MME should send this paging. Otherwise, the MME does not. The position of paging occasion is to happen in an exemplary embodiment from the time instant delta2 every paging cycle. So the equation in the example of reference 670 is to check whether there is at least one paging occasion during the remaining active time. If the above relationship is true, it means the coming PF/PO at the eNB is within the active timer or reachability timer window and the MME would send the paging to eNB. Otherwise (if the above relationship is false), the MME would not send (illustrated by reference 655) paging to eNB, as the MME determines the RRC paging could not reach the UE.

The equation and relationship in reference 670 are more easily understood through some examples. Assume delta2=100 ms, pagingCycle=1280 ms, and activetime=10 s. This means there will be paging occasions at 100 ms, 1280+100 ms, 1280*2+100 ms, 1280*3+100 ms, . . . , 1280*7+100 ms, and their indexes are 1 . . . 8. And then 1280*8+100=10.34 s is already beyond the activetime.

In more detail, assume there is a paging message arriving at the MME 170 at T=5 s. lowerround((T−delta2)/pagingCycle)=3 refers to the index of the paging occasion just “before” T. That is, lowerround((5 s−0.1 s)/1.280 s)=lowerround(4.8 s/1.280 s)=lowerround(3.75)=3, as lowerround( ) rounds down to the nearest integer. Further, upperround((T−delta2)/pagingCycle)=4 refers to the next index, i.e., the index just “after” T. Then upperround((T−delta2)/pagingCycle)*pagingCycle+delta2 is transferring “index” to the exact position of a paging occasion, i.e., 4*1280+100. If this paging occasion is less than activetime as per the relationship above, it means there is at least this paging occasion before activetime expires and the MME 170 should send this paging.

As another example, assume the paging message arrives at the MME at T=9 s. The equation in reference 670 therefore is as follows: upperround((T−delta2)/pagingCycle)=upperround((9 s−0.1 s)/1.280 s)*1280 ms+100 ms=upperround (8.9/1.280)*1280 ms+100 ms=7*1280 ms+100 ms=9.06 s, which is still less than activetime as per the relationship above, so the MME should still send the paging.

Assume, however, that the paging message arrives at the MME at T=9.5 s. Then, upperround((T−delta2)/pagingCycle)*1280 ms+100 ms=upperround ((9.5−0.1)/1.280)*1280 ms+100 ms=upperround (7.34)*1280 ms+100 ms=8*1280 ms+100 ms=10.34 s, which is greater than the activetime of 10 s per the relationship above, and the MME 170 should not send the paging.

Thus, the function upperround( ) is used in this example to find the paging occasion after T. However, this is only one example and other equations and relationships may be used.

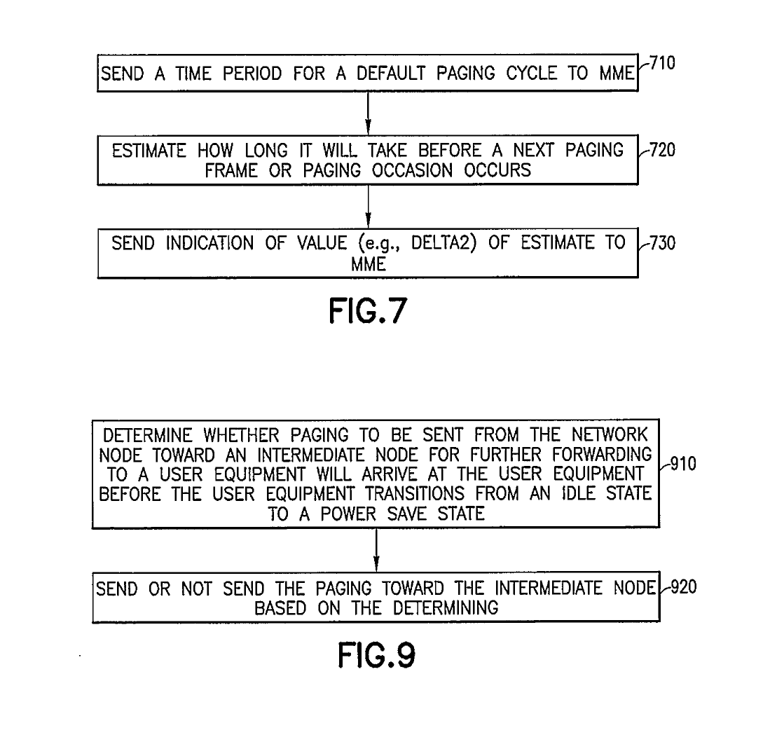

FIG. 7 is a logic flow diagram illustrating the operation of an exemplary method, a result of execution of computer program instructions embodied on a computer readable memory, and/or functions performed by logic implemented in hardware, in accordance with an exemplary embodiment. FIG. 7 is a method performed by the eNB 140, e.g., under control of the active timer assistance reporting module 151. The blocks in FIG. 7 may be considered to be interconnected means for performing the functions in the blocks. In block 710, the eNB 140 sends a time period for a default paging cycle to the MME 170. The time period may be the pagingCycle described above. In block 720, the eNB 140 estimates how long it will take before a next paging frame or paging occasion occurs. The value of the estimate is referred to as delta2 above. In block 730, the eNB 140 sends an indication of the value (e.g., delta2) of estimate to the MME 170. See, for instance, operation 14 of FIG. 6, where the eNB sends the UE context release complete message, comprising the delta2, to the MME 170.

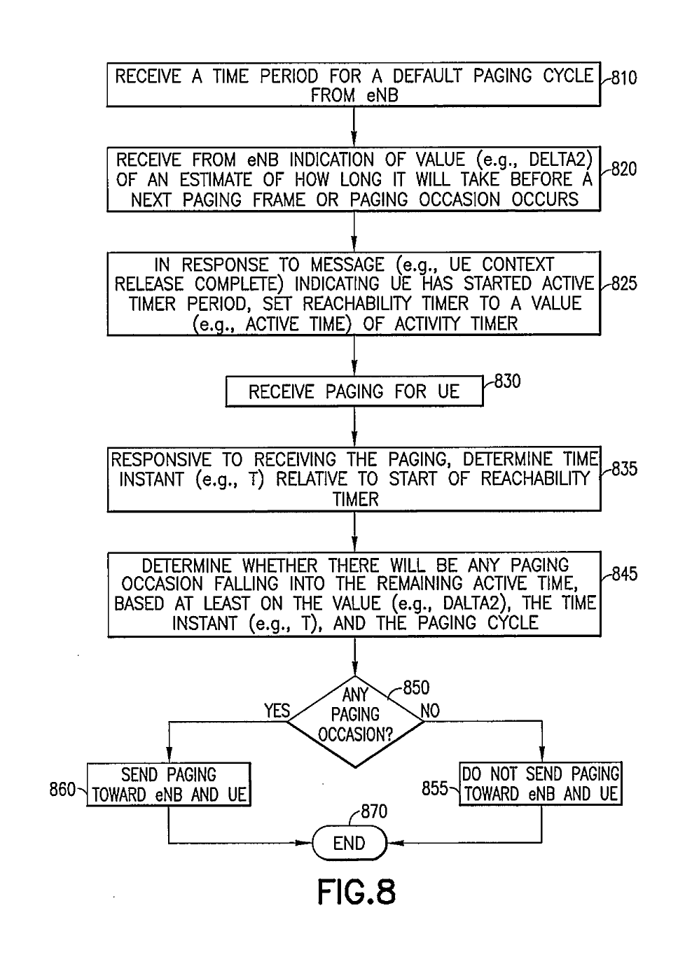

FIG. 8 is a logic flow diagram illustrating the operation of an exemplary method, a result of execution of computer program instructions embodied on a computer readable memory, and/or functions performed by logic implemented in hardware, in accordance with an exemplary embodiment. FIG. 8 is a method performed by the MME 170, e.g., under control of the active timer management module 176. The blocks in FIG. 8 may be considered to be interconnected means for performing the functions in the blocks. In block 810, the MME 170 receives a time period for a default paging cycle (e.g., pagingCycle as described above) from the eNB 140. In block 820, the MME 170 receives from the eNB 140 an indication of a value (e.g., delta2) of an estimate of how long it will take before a next paging frame or paging occasion occurs. In FIG. 6, an indication of a value is received in operation 14.

In block 825, the MME 170, in response to message (e.g., UE context release complete) indicating UE has started an active time period, sets a reachability timer 365 to a value (e.g., active time 305) of the active timer 280. In block 830, the MME 170 receives paging for the UE 110. In block 835, the MME 170, responsive to receiving the paging, determines a time instant (e.g., T) relative to the start 661 of the reachability timer 365. The MME 170 in block 845 determines whether there will be at least one paging occasion before the active timer or reachability timer expires, based at least on the value (e.g., delta2), the time instant (e.g., T), and the paging cycle. One example of this is illustrated by reference 670 in FIG. 6.

If there is no paging occasion meeting the criteria (block 850=No), then in block 855, the MME 170 does not end the paging toward the eNB 140 (and therefore through the eNB as an intermediate node 140 to the UE 110). If there is a paging occasion meeting the criteria (block 850=Yes), then in block 860, the MME 170 sends the paging toward the eNB 140 (and therefore through the eNB 140 as an intermediate node to the UE 110). In block 870, the flow ends.

Turning to FIG. 9, a logic flow diagram is shown illustrating the operation of an exemplary method, a result of execution of computer program instructions embodied on a computer readable memory, and/or functions performed by logic implemented in hardware, in accordance with an exemplary embodiment. FIG. 9 is performed by an MME, e.g., under control of the active timer management module 176. The blocks in FIG. 9 may be considered to be interconnected means for performing the functions in the blocks.

In block 910, the MME 170 determines whether paging to be sent from the network node toward an intermediate node for further forwarding to a user equipment will arrive at the user equipment before the user equipment transitions from an idle state to a power save state. For instance, the techniques in Alternative #1 (see, e.g., FIGS. 4 and 5 and associated text) or the techniques in Alternative #2 (see, e.g., FIGS. 6-8 and associated text) may be used for block 910. In block 920, the MME 170 sends or does not send the paging toward the intermediate node based on the determining. Illustratively, the MME will not send the paging in response to the MME determining paging to be sent from the network node toward an intermediate node for further forwarding to a user equipment will not arrive at the user equipment before the user equipment transitions from the idle state to the power save state. The MME will send the paging in response to the MME determining paging to be sent from the network node toward an intermediate node for further forwarding to a user equipment will arrive at the user equipment before the user equipment transitions from the idle state to the power save state.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain or store the instructions for use by or in connection with an instruction execution system, apparatus, or device, such as a computer. However, a computer-readable storage medium does not encompass propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

3GPP third generation partnership project

AS access stratum

CN core network

DL downlink (from base station to user equipment)

DRX discontinuous reception

eNB or eNodeB base station, evolved Node B (e.g., an LTE base station)

GW gateway

LTE long term evolution

MM mobility management

MME mobility management entity

ms milliseconds

MT mobile terminating

MTC machine type communication

NAS non access stratum

PDN packet data network

PDP packet data protocol

PF paging frame

PLMN public land mobile network

PO paging occasion

PSS power saving state

RAN radio access network

RAU routing area update

Rel release

RRC radio resource control

Rx or rx reception or receiver

SGW serving gateway

TAU tracking area update

TR technical report

TS technical specification

Tx or tx transmission or transmitter

UE user equipment

WI work item

What is claimed is:

1. A method, comprising:
determining at a network node whether paging to be sent from the network node toward an intermediate node for further forwarding to a user equipment will arrive at the user equipment before the user equipment transitions from an idle state to a power save state; and
sending or not sending the paging toward the intermediate node based on the determining.

2. The method of claim 1, wherein determining further comprises determining whether a time period has or has not expired, wherein the time period is based in part on an active time period used by the user equipment to determine a length of the idle state and when to transition to the power save state.

3. The method of claim 2, wherein the time period is set to the active time period minus a predetermined value.

4. The method of claim 1, wherein:
determining further comprises determining whether a time period has or has not expired, wherein the time period is determined by subtracting a predetermined value from an active time period used by the user equipment to determine a length of the idle state and when to transition to the power save state; and
sending or not sending the paging toward the intermediate node based on the determining further comprises:
sending the paging toward the intermediate node in response to the time period not expiring; and
not sending the paging toward the intermediate node in response to the time period expiring.

5. The method of claim 1, wherein:
determining further comprises determining whether there will be any paging occasion falling into a remaining active time period, wherein the active time period is used by the user equipment to determine a length of the idle state and when to transition to the power save state; and
sending or not sending the paging toward the intermediate node based on the determining further comprises:
sending the paging toward the intermediate node in response to a determination there will be a paging occasion falling into the remaining active time period; and
not sending the paging toward the intermediate node in response to a determination there will not be a paging occasion falling into the remaining active time period.

6. The method of claim 5, wherein:
the method further comprises receiving a value from the intermediate node; and
determining whether there will be any paging occasion falling into a remaining active time period further comprises determining, based at least on the value, a time instant determined based on when the paging is received, and a length of time of a paging cycle whether there will be any paging occasion falling into the remaining active time period.

7. The method of claim 5, further comprising determining the remaining active time period at least by setting a timer in response to reception from the intermediate node of a message, indicating the user equipment has transitioned to the idle state, to the active time and using at least a time instant determined based on when the paging is received and the timer to determine the remaining active time period.

8. The method of claim 7, wherein:
determining further comprises determining whether a following relationship is true: upperround((T−delta2)/pagingCycle)*pagingCycle+delta2<activetime, wherein the function upperround( ) rounds up to a nearest integer, T is a time instant determined based on when the paging is received and is relative to a beginning of the timer, delta2 is a value received from the intermediate node, the variable pagingCycle is a time period of a paging cycle, and the variable activetime is the active time period used by the user equipment;
sending the paging further comprises sending the paging toward the intermediate node in response to the relationship being true; and
not sending the paging further comprises not sending the paging toward the intermediate node in response to the relationship being false.

9. A computer program product comprising a computer-readable storage medium bearing computer program code embodied therein for use with a computer, the computer program code comprising code for performing the method of claim 1.

10. An apparatus, comprising:
one or more processors; and
one or more memories including computer program code,
the one or more memories and the computer program code configured, with the one or more processors, to cause the apparatus to perform at least the following:
determining at a network node whether paging to be sent from the network node toward an intermediate node for further forwarding to a user equipment will arrive at the user equipment before the user equipment transitions from an idle state to a power save state; and
sending or not sending the paging toward the intermediate node based on the determining.

11. The apparatus of claim 10, wherein determining further comprises determining whether a time period has or has not expired, wherein the time period is based in part on an active time period used by the user equipment to determine a length of the idle state and when to transition to the power save state.

12. The apparatus of claim 11, wherein the time period is set to the active time period minus a predetermined value.

13. The apparatus of claim 10, wherein:
determining further comprises determining whether a time period has or has not expired, wherein the time period is determined by subtracting a predetermined value from an active time period used by the user equipment to determine a length of the idle state and when to transition to the power save state; and
sending or not sending the paging toward the intermediate node based on the determining further comprises:
sending the paging toward the intermediate node in response to the time period not expiring; and
not sending the paging toward the intermediate node in response to the time period expiring.

14. The apparatus of claim 10, wherein:
determining further comprises determining whether there will be any paging occasion falling into a remaining active time period, wherein the active time period is used by the user equipment to determine a length of the idle state and when to transition to the power save state; and
sending or not sending the paging toward the intermediate node based on the determining further comprises:
sending the paging toward the intermediate node in response to a determination there will be a paging occasion falling into the remaining active time period; and
not sending the paging toward the intermediate node in response to a determination there will not be a paging occasion falling into the remaining active time period.

15. The apparatus of claim 14, wherein:
the one or more memories and the computer program code are further configured, with the one or more processors, to cause the apparatus to perform at least the following: receiving a value from the intermediate node; and
determining whether there will be any paging occasion falling into a remaining active time period further comprises determining, based at least on the value, a time instant determined based on when the paging is received, and a length of time of a paging cycle whether there will be any paging occasion falling into the remaining active time period.

16. The apparatus of claim 14, wherein the one or more memories and the computer program code are further configured, with the one or more processors, to cause the apparatus to perform at least the following: determining the remaining active time period at least by setting a timer in response to reception from the intermediate node of a message, indicating the user equipment has transitioned to the idle state, to the active time and using at least a time instant determined based on when the paging is received and the timer to determine the remaining active time period.

17. The apparatus of claim 16, wherein:
determining further comprises determining whether a following relationship is true: upperround((T−delta2)/pagingCycle)*pagingCycle+delta2<activetime, wherein the function upperround( ) rounds up to a nearest integer, T is a time instant determined based on when the paging is received and is relative to a beginning of the timer, delta2 is a value received from the intermediate node, the variable pagingCycle is a time period of a paging cycle, and the variable activetime is the active time period used by the user equipment;
sending the paging further comprises sending the paging toward the intermediate node in response to the relationship being true; and
not sending the paging further comprises not sending the paging toward the intermediate node in response to the relationship being false.

18. An apparatus, comprising:
one or more processors; and
one or more memories including computer program code,
the one or more memories and the computer program code configured, with the one or more processors, to cause the apparatus to perform at least the following:
performing an estimation at a network access node providing wireless network access to a user equipment of how long it will take before a next paging frame or paging occasion occurs for the user equipment; and
sending to a network node a value indicative of the estimation of how long it will take before the next paging frame or paging occasion occurs for the user equipment.

19. The apparatus of claim 18, wherein the estimating is performed in response to sending one of a user equipment context release complete message to the network node or performing a radio resource control connection release with the user equipment.

20. The apparatus of claim 18, wherein sending comprises sending the value to the network node in a user equipment context release complete message.
